(19) United States
(12) Patent Application Publication
(10) Pub. No.: US 2005/0033668 A1
(43) Pub. Date: Feb. 10, 2005

(54) System and method for online expense management and validation

(76) Inventors: Carol Ann Garcia, South Pasadena, CA (US); Robert John Landucci, Belmont, CA (US); Stuart Yeaton, Portland, OR (US)

Correspondence Address: GLENN PATENT GROUP, 3475 EDISON WAY, SUITE L, MENLO PARK, CA, 94025, US

(21) Appl. No.: 10/636,420

(22) Filed: Aug. 6, 2003

(51) Int. Cl. G06F 17/60

(52) U.S. Cl. 705/30

(57) ABSTRACT

A method and apparatus for allowing a vendor to: create, maintain, validate, submit, review, and print all of its invoices, such as for example air, armored, ground, and automated teller machine (ATM) fault servicing, on a secure network is provided. GUI screens are provided for inputting invoices, making invoice preparation as simple and as efficient as possible. In one embodiment of the invention, a copy invoice function is provided for a vendor to select an invoice or any detail items from a list of previously entered invoices, pull the invoice into a current invoice work area, make appropriate changes for a given month, and then submit the month's invoice. An invoice validation mechanism and various reporting mechanisms, such as for example a management reporting mechanism and an accounts payable report mechanism are also provided.

### BACKGROUND OF THE INVENTION

1. Technical Field

The invention relates generally to a method and apparatus for expense management data processing. More particularly, the invention relates to a method and apparatus for online expense management data processing and streamline invoice processing from submission through review and payment.

2. Description of the Prior Art

Typically, a flow of goods and service, information, and funds between shippers and carriers involves many laborious steps for both the carrier companies and the shipping companies, e.g. vendors. Within a typical vendor company, various departments' resources are required to assist in the support of such commerce, such as a shipping department, an accounts payable department, and delivering goods and services with a Bill of Lading to a carrier and to the accounts payable department, for example. From the information on the bill of lading, and possibly other bills of lading, the carrier periodically determines amounts it believes it is owed by the shipper and submits a freight bill to its accounts payable department. The department audits the bills and, if correct, issues payment to the vendor. It should be appreciated that when considered other factors, such as the need to rate each shipment as a function of information about an item, such as weight, size, destination, type of goods or services, applicable discounts, etc., and the rates of a particular vendor, the entire process is very complex.

For example, currently in the transportation division of an enterprise, such as a bank, there is a need to manage and control its transportation expense and streamline invoice processing all the way from submission through review and payment. There is a need to enable vendors to create an electronic invoice in a standardized format, and submit that invoice for review and approval in a paperless environment without the delays and errors that occur with a paper-based system. Furthermore, there is a need to propagate such capability throughout an entire vendor base without a need for expensive software installation and maintenance at the vendor interface.

A typical invoice review process requires a comparison between an invoiced service charge and an agreed upon servicing schedule and cost as provided for in master agreements and contract schedules along with accompanying pricing attachments and servicing details.

Thus, it would be advantageous to for an enterprise to be able to not only receive an invoice electronically, but also compare it to existing contracts and internal records of service dispatched and weight shipped all in an automated invoice validation process, thereby eliminating prior laborious manual validation processes.

Further, there is a need for a unified enterprise-wide system of record for services with the ability to deliver higher level management information as well as an ad hoc query capability for identifying areas of inefficiency and/or conducting what-if analysis for the purpose of reengineering portions of the industry network at hand.

For example, regarding the area of transportation management, what is needed is a structure that accommodates the complexities of air, armored, and ground transportation contracts and services without unduly burdening the transportation vendors. For example, presently, Wells Fargo Bank's contracts provide for flights and air lanes with many different billing methods/weight allowance structures, armored servicing agreements for automated teller machines (ATMs), cash and coin deliveries, night drop depository transit, and non-armored transportation agreements for daily check and mail pickups and deliveries throughout Wells Fargo's extensive branch and hub system.

What is needed is to be able to validate each type of invoice in an automated way. Currently, no industry standard or widely used invoice submission technology is readily available.

It would be advantageous to provide an online standardized data format with an online invoice validation feature, and also to solve such problem with the least amount of inconvenience to an enterprise's vendor base.

It would further be advantageous to provide a system and method that can handle variations in invoice format, and can handle offline file loading and editing processes resulting in format exceptions getting bounced right back to the vendor.

It would further be advantageous to provide a real-time connection to the vendor, so that the vendor can validate invoice charges against the servicing records to guarantee that a correct invoice is being submitted right from the start.

It would further be advantageous to provide a structured input screen and a view of all invoices and invoice status, so those vendors can manage their billings in a more efficient manner.

It would further be advantageous to provide means for all parties (enterprise and vendors, for example) to view the same information at the same time without multiple versions of an invoice existing in different places at the same time.

### SUMMARY OF THE INVENTION

A method and apparatus for allowing a vendor to: create, maintain, validate, submit, review, and print all of its invoices, such as for example air, armored, ground, and automated teller machine (ATM) fault servicing, on a secure network is provided. GUI screens are provided for inputting invoices, making invoice preparation as simple and as efficient as possible. In one embodiment of the invention, a copy invoice function is provided for a vendor to select an invoice or any detail items from a list of previously entered invoices, pull the invoice into a current invoice work area, make appropriate changes for a given month, and then submit the month's invoice. An invoice validation mechanism and various reporting mechanisms, such as for example a management reporting mechanism and an accounts payable report mechanism, are also provided.

### BRIEF DESCRIPTION OF THE DRAWINGS

FIG. 1 is a schematic diagram showing the main components and their respective relationships according to the invention;

FIG. 2 is a schematic diagram of an example data structure according to the invention;

FIG. 3 is a schematic flow diagram of an example of various entities or groups handling an invoice from creation to approval according to the invention;

FIG. 4 is a screen print of a sample security request form according to the invention;

FIG. 5 is a Change Password screen according to the invention;

FIG. 6 is a Select Office screen according to the invention;

FIG. 7 is a Main Menu screen according to the invention;

FIG. 8 is an Enter New Invoice screen according to the invention;

FIG. 9 is an Enter New Armored Invoice screen according to the invention;

FIG. 10 is a timer display according to the invention;

FIG. 11 is a second portion of the Enter New Armored Invoice screen according to the invention;

FIGS. 12-14 show an Enter New Air Invoice screen according to the invention;

FIGS. 15-17 show an Enter New Ground Invoice screen according to the invention;

FIG. 18 is an Invoice Import screen according to the invention;

FIG. 19 is an example A/P Invoice screen according to the invention;

FIG. 20 is an example A/P Invoice screen according to the invention; and

FIG. 21 is a Security Request Form screen according to the invention.

### DETAILED DESCRIPTION OF THE INVENTION

A method and apparatus for allowing a vendor to: create, maintain, validate, submit, review, and print all of its invoices, such as for example air, armored, ground, and automated teller machine (ATM) fault servicing, on a secure network is provided. GUI screens are provided for inputting invoices, making invoice preparation as simple and as efficient as possible. In one embodiment of the invention, a copy invoice function is provided for a vendor to select an invoice or any detail items from a list of previously entered invoices, pull the invoice into a current invoice work area, make appropriate changes for a given month, and then submit the month's invoice. An invoice validation mechanism and various reporting mechanisms, such as for example a management reporting mechanism and an accounts payable report mechanism, are also provided.

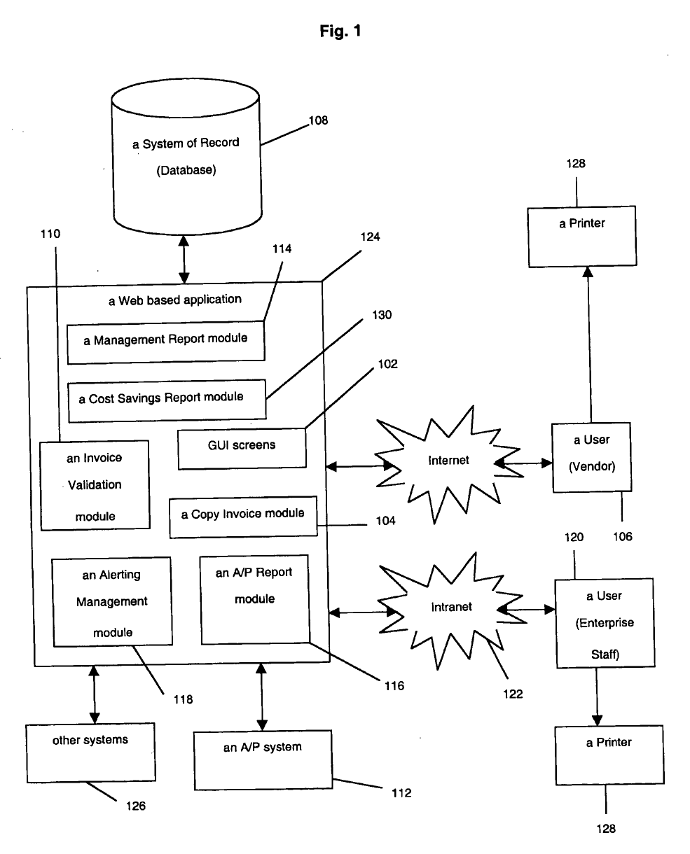

An embodiment of the invention can be described with reference to FIG. 1, schematic diagram showing the main components and their respective relationships according to the invention. GUI screens 102 are provided for interfacing with the user. The user can be a vendor 106 or an enterprise staff member 120 for example. The GUI screens 102 are used for example for inputting invoices, making invoice preparation as simple and as efficient as possible, and for uploading data input files. The user can also be an enterprise staff member 120 linked to the application through a network, such as an Intranet 112. The enterprise staff member performs particular functionalities, such as inputting and updating master contract data between the enterprise and vendors, agreed upon pricing for specific services, details about the services, and the like.

In one embodiment of the invention, a copy invoice function 104 is provided for a vendor 106 to select an invoice or any detail items from a list of previously entered invoices stored in a system of record repository 108, pull the invoice data into a current invoice work area, make appropriate changes for a given time period such as a month, and then submit the invoice. The invoice proceeds to an invoice validation mechanism 110 and after validation onto an accounts payable component 116, which provides a report suitable for and usable by the enterprise's A/P system 112. The invention also provides reporting functionality. Specifically, a management reporting module 114 is provided for management or analysts to review the data within the repository at any point in time.

It should be appreciated that the invention is described with reference to a specific application of a bank's expenses in the area of transportation and ATM fault servicing. Such area of application is meant by example only. Many other areas of application are possible and are still within the scope and spirit of the invention. Examples of such areas of application using invoices are financial institutions, the insurance industry, healthcare industry, and retail industry.

The preferred embodiment of the invention is an Internet based, i.e. Web based, application 124 that allows vendor invoice control and functionality from the vendor accounting offices to an enterprise, such as a bank. An extensive security mechanism is provided by which assigned users are limited to appropriate specific vendors, offices, and invoices, thereby protecting the privacy of data across vendors.

Also, according to the invention, the enterprise provides structured invoices to the vendors. The invoices are structured according to particular criteria and to a particular format to guide vendors on inputting invoice data and for subsequently submitting the invoices through the GUI screens 102. Thus vendors are allowed to be solely responsible for the invoices and changes made to them. The enterprise, on the other hand, is responsible for and uses the invoice validation module 110 for either rejecting the submitted invoice back to the vendor or for validating and approving the invoice for payment.

Also, the provided Web based software is user-friendly and when rejecting an invoice allows, for example, for rejection comments to be entered on the detail lines, and provides the changes in a different color font on the detail line for ease of detection. Once the invoice data is corrected and all information is correct, the invoice status is changed to verified and the invoice is approved. The final process, after the approval, is performed by an accounts payable module 116, which creates an actual invoice that is sent to the enterprise's accounts payable (A/P) division 112.

In the example application of the invention discussed herein, the system provides functionality for four different types of vendors: armored, air, ground, and ATM fault servicing. Through secure administration files that specify the information about the vendor, the invention provides the appropriate screens to input invoices.

In the case of air vendors, among expected input are air bill numbers and weights. An Import function is provided by the invention that allows the vendor to create and import a pipe delimited file. For large air carriers with many detail items, such importing functionality is preferable and advantageous because it is efficient. According to the invention, the import functionality provides the same information editing capability as does the input screens, thus reducing the amount of errors introduced into the system due to inconsistent input for example.

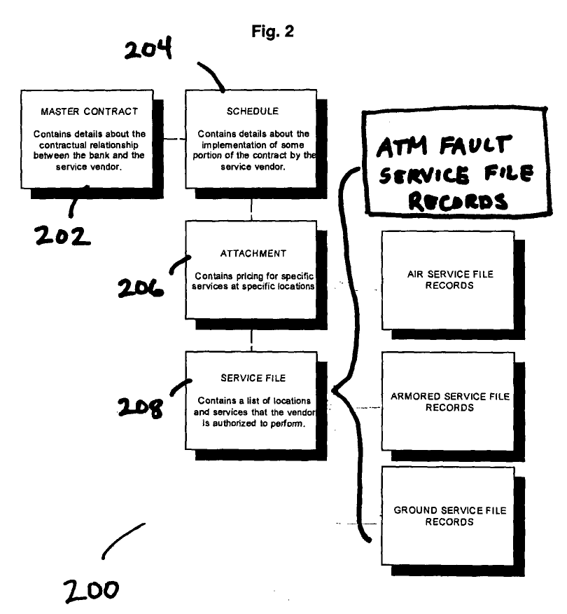

The preferred embodiment of the invention provides invoice validation. Each of a vendor's contracts relates to a set of specific charges or costs for each service provided. For example, such charges may be identified by an ATM division, a Store division, a Flight division, etc. These charges are negotiated before the agreement is reached. The agreed upon costs and services are the basis of attachment files 206 and service files 208 provided by the invention, as depicted in FIG. 2, a schematic diagram of an example data structure. These attachment files 206 and service files 208 contain each location and charges associated with unique costs per service to each location. Thus, the service file 208 is used to validate each line item on a vendor's invoice.

It should be appreciated that for air vendor routes that most often have weight limits and excess charges for weight overages, the preferred embodiment of the invention provides calculation algorithms to validate the invoice line item.

The invention also provides for interfacing to existing tracking systems 126 for determining the actual weight that an enterprise ships on a route. The invention then checks the determined actual shipped weight against the weight on the invoice that the enterprise receives from the vendor. In addition, the invention provides capability for an enterprise to determine the cost that should be charged for the shipped weight by referring to the master contract information 202 regarding what was agreed upon. Thus, the invention provides for verifying not only the weights carried but also the charges levied by a vendor.

The invention also provides reporting mechanisms, such as the management reporting module 114 of a servicing network, such as an air network. By using informational data such as, service level agreements, lane, and flight origination, destinations and times, categories of the kinds of shipments, weights and contracted costs, the efficiency and effectiveness of an enterprise's network can be determined.

The invention also provides an accounts payable report module 116 for submitting invoice reports directly to an enterprise's accounts payable department for payment. Such reports contain all the appropriate information for an accounts payable system 112 to process. Some of the types of information are remittance address, payment terms, informational data (e.g. control numbers) for the charges, approval signature box, etc.

The invention also provides an alerting management module 118 for alerting users of variances, such as weight variances, different contingency planning and variances in information from performing vendor comparisons, e.g. flight comparisons.

In addition, the invention also provides capability for offloading its invoices to a spreadsheet. The invention also provides a report of an invoice that is printable, for example by a user's printer 128.

### An Exemplary ATM Fault Servicing Embodiment

According to the invention, vendors providing ATM fault servicing fall into one of two groups: a first line and a second line. Those vendors responding to first line issues do so via a dispatch from a bank's ATM monitoring systems. Such first line services include fault servicing that does not require a machine repair such as a cash jam, card jam, or receipt paper outage. Vendors performing such services are on call, and are dispatched to the corresponding ATM in response to a fault signal from the ATM to the bank's monitoring system. When the fault is cleared, the ATM signals that it is fully operational and the trouble ticket is closed out.

The second type of fault servicing, second line, includes ATM repair services. Unlike the first line of services, such type of service requires a repair, and often requires parts replacement. Leading ATM manufacturers typically are active providers of such service.

The invention accepts ATM fault servicing invoices and verifies the particular line of service against a vendor's contract and against the trouble ticket issued for the fault call being invoiced. The vendor provides the trouble ticket number in the invoice line is an incident number or indicator field. The invention also enables the validation of the dispatch using daily file extracts from the bank's fault monitoring systems into a data table.

In one embodiment of the invention, ATM fault servicing attachments provide for pricing by region, by ATM model, and by individual ATM. The invention also provides for agreements with unlimited calls and those with call limits per ATM, either aggregated across all ATMs, or by ATM, with specified charges for excess calls. Non-dispatched services such as special projects are also accommodated resulting in a complete electronic invoicing environment for all fault servicing.

Invoices for second line calls that require a dispatched call for repair include the incident number or indicator, a labor charge for the repair time, and a parts charge for parts replacement. Such invoices have the dispatch validated against the monitoring system extract, repair time, parts charge, and against an agreed upon list of parts prices by vendor and part number.

According to the invention, the GUI screens for ATM fault servicing invoices and attachments and service files are unique to such service.

It should be appreciated that the GUI screens have the look and feel of the other types of screens used for the other types of services, such as transportation services. The vendor office screen, main menu and other general screens discussed herein below accommodate any the new type of service with little or no modification.

### Design Goals

Following is a list of goals of the invention:
Eliminate paper invoices and reduce invoice errors;
Eliminate the possibility of paying more than agreed upon for service rendered;
Eliminate paying for service not delivered;
Eliminate the man hours spent on invoice review and vendor communication;
Reduce invoice cycle time from submission through payment;
Streamline the invoice approval process, e.g. mouse click authorization to replace mailing of invoices, signatures, and filing;
Improve audit trail, e.g. from invoice submission to bank review to authorization to accounts payable (A/P) to paid status;
Create a central database of locations serviced, services, costs, contracts, and vendors, i.e. a single system of record;
Improve expense tracking and reporting to the level of individual services;
Improve expense planning and forecasting;
Provide a platform for integrating operations applications to validate service levels and vendor billing;
Easily detect machines, such as ATMs, requiring excessive servicing, for example across all regions and across all vendors;
Explore opportunities for conjunctive service to remote and high cost locations, i.e. reduce transportation expense through partnering with other banks on conjunctive transportation routing;
Reengineer air lanes to benefit from lower cost routing;
Detect over-charges on shipments, e.g. air, by validating reported weight against a company's own measurements, perhaps as captured by an internal tracking system;
Better manage contracts to negotiate new terms prior to expiration and/or take new bids earlier in the process;
Provide for database extracts for existing servicing files and costs and automatically replacing such files with newly generated service files and costs based on RFP proposals and automatically evaluating current costs to RFP proposal costs;
Provide an ad hoc reporting and data warehousing environment for one-off reports and what-if analysis. That is, provide one time management reports requests. As an example, management might want to determine the impact if the enterprise buys a bank and moves 50 new stores on a particular air flight, or opens 10 new ATMs in a specific service area. That is, what is the impact to costs and vendor routes if something is changed?
Be able to integrate an acquired institution's expense management responsibilities even when the existing management environment is decentralized; and
Easily provide other enterprise divisions with up-to-date cost and servicing information.

The invention advantageously provides a unique platform, a unified database environment, with contract and invoice information, and feeds and extracts from operations-based applications. The invention also provides unique table structure design, user interfaces (screens), and invoice validation logic. Unique screens for each type of service are provided. The complexity of the service structure is reduced to easy-to-use edit screens for database maintenance. Vendor input screens are elegant invoice screens that accept either key input through a browser or file upload from the vendor's billing system.

### Data Hierarchy

The invention provides a hierarchy of data that is described with reference to FIG. 2, a schematic diagram of example data according to the data hierarchy of the invention. Specifically, the example data is for an enterprise that is a bank and the managed area of service is transportation and ATM fault servicing.

That is, in addition to providing a repository of vendor invoices 108, invention maintains five levels of vendor service information, as follows:
Each vendor has one or more contracts to provide services 202.
One or more schedules can be created for any given contract 204.
One or more attachments 206 can be created for any given schedule. In this example, an attachment is associated with a specific vendor office. Attachments store prices for all services based on service code and, in the case of armored service, a series of other factors. A single attachment can hold several sets of prices, each covering a different range of dates.
One or more service files 208 can be created for any given attachment. The service file contains a list of the services for any given and authorized location of a given vendor.
Each service file 208 is composed of one or more records. In this example, data is stored separately according to the different objects it represents, such as for example air, armored, ground, and ATM fault servicing service file records. That is, a service file 208 can contain only one type of data: air, armored, ground, or ATM fault servicing.

It should be appreciated that such hierarchy of data is absolute. If no contract exists, then no service information for the vendor is in the system.

### Functionality Description

Following is a summary of several functional aspects of validating invoices and reducing expenses provided by the invention.

Invoice Collection

The invention provides a repository of invoices 108, such as from air, armored, ground, and ATM fault service vendors. A vendor logs into the application 124 and manually creates a new invoice, copies from a prior invoice, or uploads whole invoices using a delimited file format.

Servic Data Loading

The preferred embodiment of the invention provides for new attachments and service files to be created in the system by loading data from preexisting sources, such as spreadsheets. These spreadsheets adhere to formatting rules defined for the specific type of data being loaded.

Effective Dating

Each schedule 204, attachment 206, service file 208, and service file record 208 carries both a start and an end date. These dates allow for actual invoices to be specifically matched by the date of service such against such service file records 208 during the invoice validation process.

The invention also provides screening functionality which enforce effective dating by automatically expiring old records and creating new ones when the user chooses to modify existing services or pricing. Older records are retained for future validation of invoices that have not yet been submitted. The user may also choose to explicitly close an attachment 206 or service file 208 without creating a new one.

Date Synchronization

The invention allows a schedule 204 to be designated on a periodic basis, such as by a month-to-month schedule. Each period is automatically extended. For example, month-to-month schedules are automatically extended by one month after they have expired.

That is, the end date for attachments 206 and service files 208 tied to an extended schedule 204 are also extended unless the user has chosen to explicitly terminate the record, i.e. render it expired. This process makes maintenance of attachment 206 and service file 208 data considerably easy.

The date synchronization process works according to the provided data hierarchy 200. Thus, if the users set an end date for an attachment 206, then the user has closed the service files and service file records 208 associated with that attachment 206 as well.

Invoice Validation

The invention also provides the capability to validate invoices entered or uploaded by service providers against the list of contracted services of the master contract 202 for that vendor. This capability allows for identifying erroneous or fraudulent billing by vendors.

Enterprise staff members, such as individual analysts, are able to final control over whether or not an invoice is paid.

The invention also provides a cost savings report module 130 for presenting calculated savings accumulated through the invoice validation process by using stored before and after images of the invoice in the system of records 108. This allows for the system to produce a simple report of savings based on a specified range of dates. Savings can be calculated in multiple ways. However, a direct view of savings is gained by subtracting the amount of the final invoice from the amount of the initial invoice. Additional data is also collected and stored in the database 108 to facilitate later analysis of the data.

Ad Hoc Functionality

The invention also provides the capability to query and present information in an ad hoc manner. In one embodiment of the invention, invoice, attachment, and service file data are presented in table view. A user easily queries any information from such table views.

Specifically, using the ad hoc functionality a user can construct what-if scenarios. By constructing such what-if scenarios, the user gleans areas of high cost and other inefficiencies to the enterprise.

### An Exemplary Expense Management and Validation System

An exemplary system described herein below is applied to a major bank's transportation and ATM fault servicing expense management and validation division. It is assumed that the division manages air, armored, ground, and ATM fault services and related expenses. The division negotiates and tracks the contracts. It monitors and approves payment of all transportation and ATM fault related vendor invoices.

The exemplary expense management system is an Internet based application allows for: creating, maintaining, submitting, validating, reviewing, and printing all transportation invoices, such as air, armored, and ground, and ATM fault servicing invoices online. It is based on the vendor creating its own invoices. Each type of service is associated with a particular set of GUI screens, some of which are described herein below.

### Example Transportation Related GUI Screens and Data

The Life of an Invoice

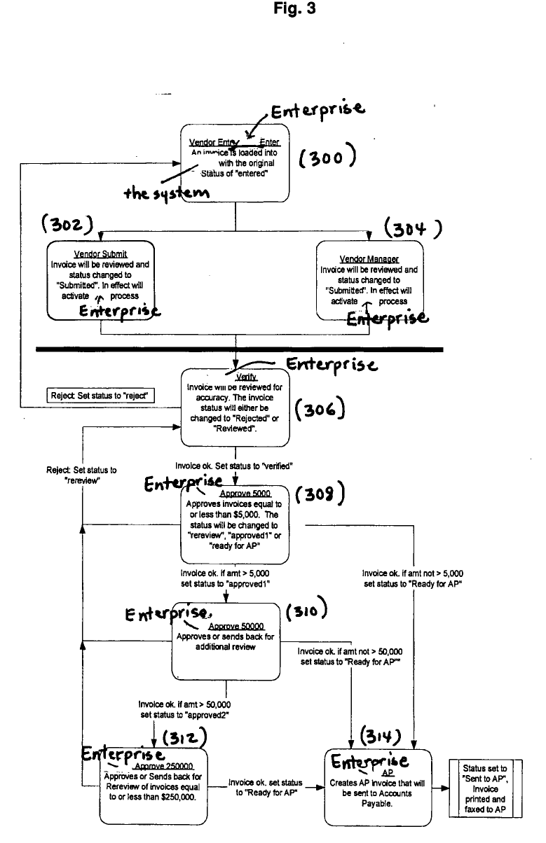

FIG. 3 is a schematic flow diagram of an example of various entities or groups handling an invoice from creation to approval according to the invention.

About Groups

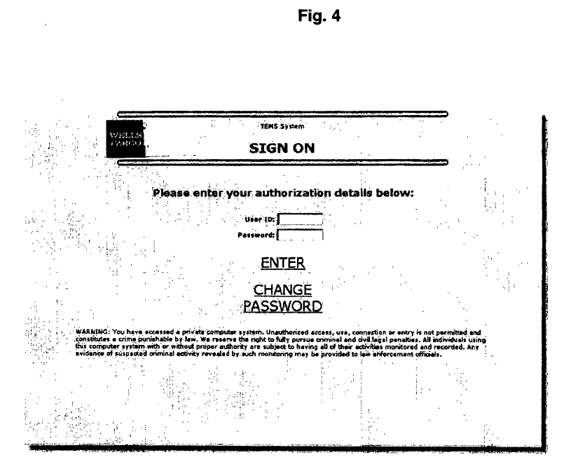

It should be appreciated that certain users of the system have certain functions and responsibilities. Thus, not every user sees the same options. According to the preferred embodiment of the invention, when a user signs on to the system, the username and password are recognized by the system and specific privileges are determined by a particular associated group. A vendor analyst establishes the user id and password. Vendor analysts preferably submit a Security Request form, such as one depicted in FIG. 4, a screen print of a sample security request form according to the invention.

Below in Table A is an example of a list of groups and their functions. Refer to FIG. 3.

TABLE A

| Group Name | Functions Within System |
|---|---|
| Vendor Entry (300) | Import files |
| | Enter new invoice |
| | Copy invoice |
| | Edit existing invoices |
| | Generate invoice reports |
| | Produce an spreadsheet file from an invoice |
| | Delete invoices |
| Vendor Submit (302) | Generate invoice reports |
| | Produce a spreadsheet file from an invoice |
| | Submit invoice to Enterprise |
| Vendor Manager (304) | Import files |
| | Enter new invoice |
| | Copy invoice |
| | Edit existing invoices |
| | Generate invoice reports |
| | Produce a spreadsheet file from an invoice |
| | Delete invoices |
| | Submit invoice to Enterprise |
| Enterprise (e.g. Bank) | This group user will enter invoices for a vendor |
| Enter (300) | that does not or cannot enter their own invoice. |
| | Import files |
| | Enter new invoice |
| | Copy invoice |
| | Edit existing invoices |
| | Generate invoice reports |
| | Produce a spreadsheet file from an invoice |
| | Delete invoices |
| | Change status to Reviewed |
| Enterprise Verify (306) | This group user will be the first user to review |
| | any invoices for accuracy. |
| | Generate invoice reports |
| | Produce a spreadsheet file from an invoice |
| | Change status to Rej cted |
| | Change status to R view d |
| Ent rprise Manager | This grou is administrative. |
| | Generate invoice reports |
| | Produce a spreadsheet file from an invoice |
| | Vendor office maintenance |
| | User maintenance |
| | AU lookup maintenance [Inventors: what is |
| | AU?] |
| Enterprise Approve | This group has signing authority not to exceed |
| $5,000 (308) | $5,000. |
| | Invoices that are under this amount can have |
| | their status changed to A/P. |
| | Generate invoice reports |
| | Produce a spreadsheet file from an invoice |
| | Change the status to Rejected |
| | Change the status to Reviewed |
| | Change the status to Approved1 for invoices |
| | greater than $5,000 |
| | Change the status to Ready for A/P for invoices |
| | less than $5,000 |
| Enterprise Approve | This group has signing authority not to exceed |
| $50,000 (310) | $50,000. |
| | Invoices that are under this amount can have |
| | their status changed to A/P. |
| | Generate invoice reports |
| | Produce a spreadsheet file from an invoice |
| | Change the status to Rejected |
| | Change the status to Reviewed |
| | Change the status to Approved2 for invoices |
| | greater than $50,000 |
| | Change the status to Ready for A/P for invoices |
| | less than $50,000 |
| Enterprise Approve | This group has signing authority not to exceed |
| $250,000 (312) | $250,000. |
| | Invoices that are under this amount can have |
| | their status changed to A/P. |
| | Generate invoice reports |
| | Produce a spreadsheet file from an invoice |
| | Change the status to Ready for A/P for invoices |
| | less than $250,000 |
| Enterprise A/P (314) | This group has the authority to create A/P |
| | invoice reports that will be sent to Accounts |
| | Payable. |
| | Generate invoice reports |
| | Produce a spreadsheet file from an invoice |
| | Print an A/P report |
| | Change the status to Sent t A/P |
| Administrator | This group is responsible for maintenance of |
| | the system. |
| | User maintenance |
| | Vender maintenance |
| | Service code maintenance |
| | Security group maintenance |
| | AU lookup maintenance |
| | Location maaintenance |

Exemplary Screen Overviews

This section describes user screens of the exemplary expense system according to one preferred embodiment of the invention.

It should be appreciated that depending on user level, some screens are not seen or used by a particular user. Additionally, some features on the screens may not be available to particular users. The user level determines user access level. Before discussing each screen, a list is provided stating what a particular user may or may not see on that particular screen.

The following screens are covered in this section:
Sign On Screen
Change Password Screen
Select Office Screen
Main Menu Screen
Enter New Invoice Screen
Enter New Armored Invoice Screen
Enter New Air Invoice Screen
Enter New Ground Invoice Screen
Import Invoice File Screen
A/P Invoice Screen
Security Request Screen
   Sign On Screen

The Sign On screen is the homepage for the exemplary system. As the gateway into the exemplary system, it is the first screen accessed when entering the URL for the system. The Sign On screen allows for: entering user ID, entering password, and changing a password.

Every user has access to this screen.

The Sign On screen has the following fields and buttons depicted in Table B. Also, please refer to FIG. 4, an example input screen for system according to the invention.

TABLE B

| | |
|---|---|
| User ID | Enter your unique user ID assigned to you by |
| | Enterprise. |
| Password | Enter your password. Password must be alphanumeric |
| | and at least six digits long. |
| Enter | Click on Enter or press Enter on your keyboard to |
| | accept your user ID and password. This will take you |
| | to the Select Office menu. |
| Change Password | Opens a new screen allowing you to create a new |
| | password. All passwords in the system will expire in |
| | 30 days. After that, you must create a new password. |

Change Password Screen

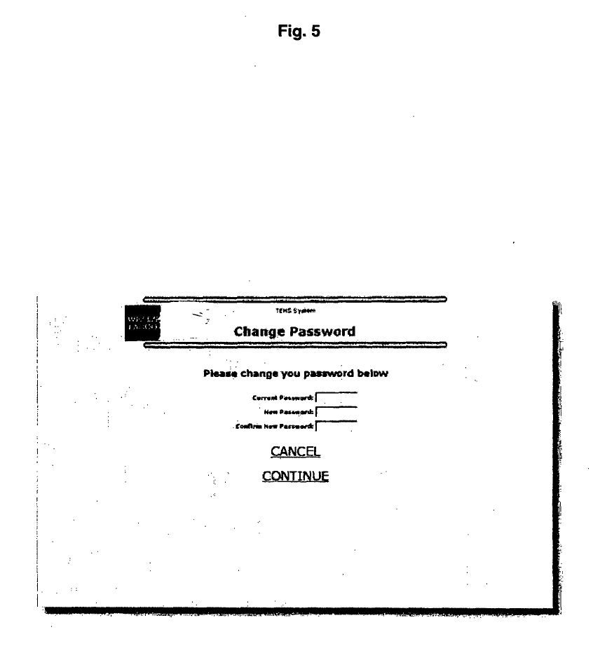

Every user has access to this screen. Please refer to FIG. 5, a change password screen according to the invention.

The Change Password screen allows for changing a current password, and it contains the following fields and buttons depicted in Table C herein below.

TABLE C

| | |
|---|---|
| Current Password | Enter your current password. |
| New Password | Enter your new password. |
| Confirm New Password | Re-enter your newly created password. |
| Cancel | Click to cancel the changing password process. |
| Continue | Click to accept your new password. |

Select Office Screen

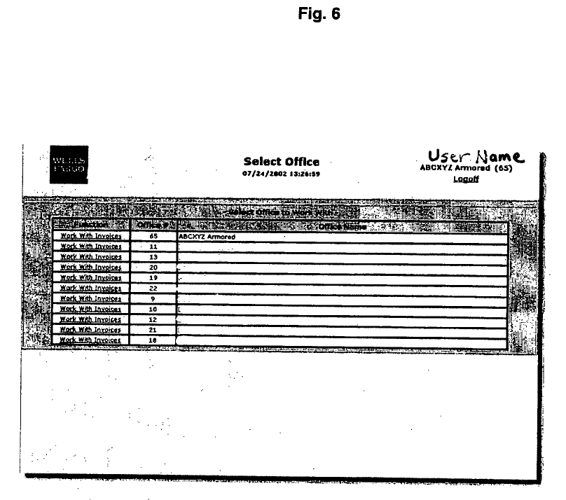

The Select Office screen displays a list of office names that are associated with the individual's logon access. Every user has access to this screen; however, users will have different offices displayed depending on their access. All of this is configured when setting up user access. Refer to FIG. 6, a select office screen according to the invention.

Access can be assigned for all of a given vendor's offices, or may be limited. For example, an accounting manager may have access to all of a particular vendor's offices, but another user from an individual office may have access only to that particular office.

The Select Office screen contains the following items as depicted in Table D herein below.

TABLE D

| | |
|---|---|
| Logoff | Logs the user off of the system. |
| Function | Contains the item, Work With Invoices. When clicked, |
| | displays the Main Menu for that office. |
| Office Number | Read-only field that displays the office number. |
| Office Name | Read-only field that displays the office name. |

Main Menu Screen

The Main Menu screen allows entering a new invoice, importing an invoice file, editing an existing invoice, getting a report of an existing invoice, or opening a spreadsheet file. When selecting an office to work with, the Main Menu opens and is associated with that particular office.

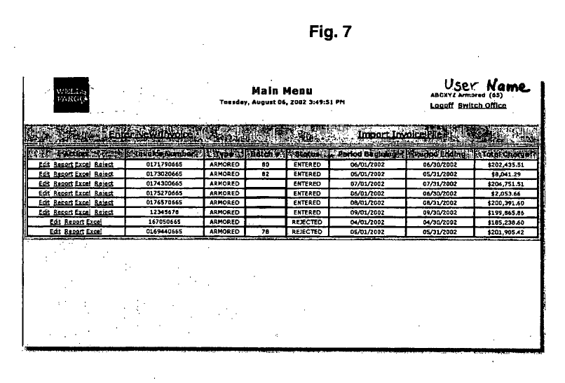

The Main Menu contains different features depending on user type. For this reason, every feature is discussed herein below in Table E. Please refer to FIG. 7, a main menu screen according to the invention.

The Main Menu is accessible for every group member and has the following features as depicted in Table E below.

TABLE E

| | |
|---|---|
| Logoff | Logs the user off the system. |
| Switch Office | Takes the user back to the Select Office screen. |
| Enter New Invoice | Opens the Enter New Invoice screen. |
| Import Invoice File | Opens the Import File screen. For more |
| | information on this screen, see Import File Screen |
| | herein below. |
| Action | Clickable field that has the following items: |
| | Edit-Opens the Edit Invoice screen. |
| | Report-Opens the Invoice Report for that invoice. |
| | Excel-Opens the invoice in an Excel ® file. |
| | A/P Invoice-Displays the read-only A/P invoice. For |
| | an example of what this looks like, see A/P Invoice |
| | herein. |
| Invoice Number | Read-only field that displays the invoice number. |
| | The invoice number is entered on the Enter New In- |
| | voice screen. |
| Type | Read-only field that displays the type. The type is |
| | entered on the Enter New Invoice screen. |
| Batch Number | Read-only field that displays the batch number. |
| Status | Read-only field that displays the current status of the |
| | invoice. There can be various statuses listed in this |
| | field. For a complete list of statuses, please Status |
| | Codes herein below. |
| Period Beginning | Read-only field that displays the invoice beginning |
| | date. The beginning date can be entered on the Ent r |
| | New Inv ic screen, herein below. |
| Peri d Ending | Read-only field that displays the invoice ending |
| | date. The ending date can be enetered on the Enter |
| | New Inv ice screen. |
| Total Charge | Read-only field that displays the total change for the |
| | invoice. |

Enter New Invoice

The Enter New Invoice screen is where basic information about the invoice such as: customer name, date, beginning/ending dates, etc. is entered. The information input on this screen comprises the header information on the invoices.

The Enter New Invoice screen is accessible to the following groups: Vendor Entry, Vendor Manager, and Enterprise Enter, as discussed herein above.

It should be appreciated that in this example, once content to this screen is added, the flow goes to the next screen, the Invoice Type and the Invoice State fields cannot be changed.

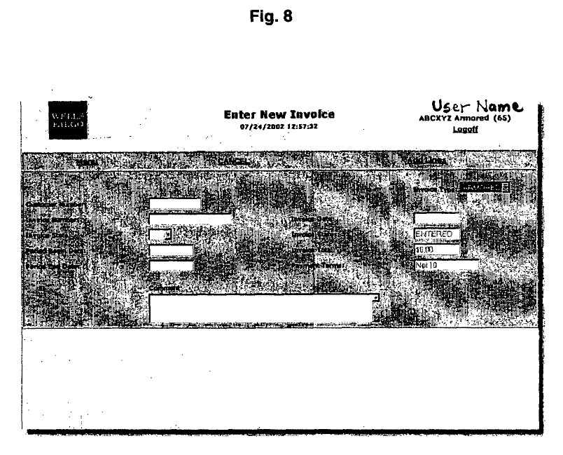

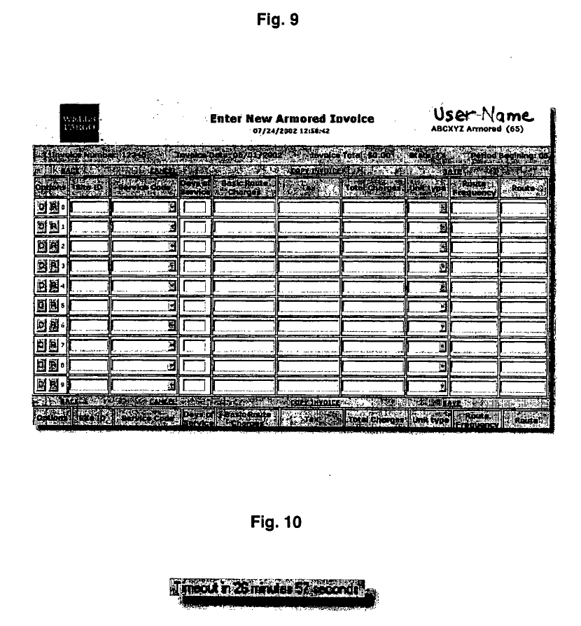

Refer to FIG. 8, an Enter New Invoice screen according to the invention.

The following fields in Table F below are found on Enter New Invoice screen.

TABLE F

| | |
|---|---|
| Logoff | Logs the user off of the system. |
| Menu | Saves the information on the screen and returns the |
| | user to the main menu. |
| Cancel | Cancels the Enter New Invoice screen without |
| | saving any content. Choose this if you do not wish |
| | to keep any of the information, the user will be |
| | returned to the main menu. |
| Add Lines | Displays additional lines that allow you to continue |
| | with the invoicing process. The Ent r N w Arm r d |
| | Invoic screen will be displayed. For more informa- |
| | tion on this screen, please see Enter N w Armor d |
| | Invoice herein below. |
| Invoice Type | Drop-down box that contains the different invoice |
| | types. The choices are Arm red, Ground, Air, and |
| | Credit. For an example of an Armor d invoice, see |
| | herein below. For an example of a Gr und invoice, |
| | see herein below. For an example of an Air invoice, |
| | see herein below. |
| Customer Number | Enter the number of the customer or account that |
| | refers to the Enterprise location being billed. |
| Invoice Number | Enter your invoice number in this effect. The |
| | number can be up to 20 spaces and aliphanumeric. |
| | This field is required. |
| Invoice Date | Enter the date the invoice is created. This field |
| | is required and must be in the following format: |
| | mm/dd/yy. |
| Invoice State | Drop-down box that contains two-letter state |
| | abbreviations. This field is required. |
| Invoice Status | Read-only field that displays the current |
| | status of the invoice (set to Entered by default). |
| | There are several possible statuses that are available. |
| | For a complete list, see Status Codes herein below. |
| | The vendor manager will set the status. |
| Period Begin Date | Enter the date this invoice starts or covers. |
| | This field is required and must be in the following |
| | format: mm/dd/yy. |
| Period End Date | Enter the date this invoice ends. This field is |
| | required and must be in the following format: |
| | mm/dd/yy. |
| Invoice Total | Read-only field that calculates the total. |
| Comments | Used as a field to add comments or additional infor- |
| | mation about the invoice. |

Enter New Armored Invoice

Refer to FIG. 9, an Enter New Armored Invoice screen according to the invention. This screen is displayed when selecting Add Lines on the New Invoice screen and is available to the following groups: Vendor Entry, Vendor Manager, and Enterprise Enter.

The Enter New Armored Invoice screen allows adding specific information to the invoice.

It should be appreciated that when accessing the Enter New Armored, Air, or Ground Invoice screens, a timer appears in the lower left corner. As soon as a user logs on, the session is timed. For example, in one embodiment of the invention, a user has 30 minutes to fill in invoice information. If the input information is not saved before such time expires, all unsaved information is lost. If information is saved before the timer expires, the timer resets itself.

Please refer to FIG. 10, a timer display according to the invention.

The following fields depicted in Table G herein below are located on this screen.

TABLE G

| | |
|---|---|
| Invoice Number | Read-only field that displays the invoice number |
| | entered on the Enter New Invoice screen. |
| Invoice Date | Read-only field that displays the invoice |
| | creation date. |
| Invoice Total | Read-only field that displays the invoice |
| | total. This value is generated by the system. |
| State | Read-only field that displays the state |
| | associated with the invoice. |
| Period Beginning | Read-only field that displays the beginning |
| | period of the invoice. |
| Period Ending | Read-only field that displays the ending |
| | period of the invoice. |
| Comments | Read-only field that contains any comments |
| | that are associated with this invoice. |
| Back | Takes the user back to the Enter New Invoice |
| | screen. |
| Cancel | Cancels the new invoice process without saving |
| | any information. Takes the user back to the Main |
| | Menu. |
| Copy Invoice | Opens the Copy Invoice screen. Please see |
| | Copy Invoice Screen herein below for more |
| | information. |
| Save | Saves the information and displays an additional |
| | 20 lines for more information. |
| Save & Exit | Saves the information and takes the user to |
| | the Main Menu. |
| Options | The Options column contains two buttons. |
| | D-Deletes a keyed or partially keyed line. Only |
| | delete if the user no longer needs or wants the |
| | information in the line. All information in that |
| | line will disappear and Deleted will show in the |
| | line detail. The user can key on a deleted line. |
| | If the user does not key on a deleted line, it |
| | will remain as a detail line until SAVE is |
| | selected. After saving, it will no longer be part |
| | of the invoice detail. |
| | R-Repeats a line. Select R on the Line item the |
| | user wishes to repeat. The user can select a line |
| | to repeat from a keyed item on the invoice. All |
| | fields of the repeated line will show in the next |
| | available blank line. |
| Site ID | Used to identify the service location. This field |
| | is used to input all types of armored, ground, |
| | and air services. The various types of information |
| | include: ATM ID, AU for Branch Cash service, an |
| | AU or other identifier for night drop service, or |
| | an identifier for Remote/Stem/Shuttle service. This |
| | field is set as alphanumeric, input will automatically |
| | capatilize when the user moves to the next field. At |
| | this time, when the user keys an ATM that is |
| | currently in NASCAR and associated in NASCAR |
| | with the vendor office (vendor office from the main |
| | menu screen), the Route, Site Name, Address, City |
| | and State information will automatically be filled. |
| | If the line detail is not an ATM or is not an |
| | ATM in NASCAR, the location detail listed above |
| | will not be filled and must be keyed directly into |
| | the screen. |
| Service Code | Required field that has a drop-down list that |
| | contains the service codes. For a complete list |
| | of service codes, please see Service Codes for |
| | Armored herein below. |
| Quantity of Service | This is a multiplier field. It must be |
| | numeric and is multiplied by the Basic Route |
| | Charges. Numeric value can contain decimals. If |
| | service is billed based on the number of times |
| | the service is done, then the number of times is |
| | keyed in the Quantity of Service field and the |
| | per service rate is in the Basic Route Charges |
| | field. If the service is billed based on a flat |
| | monthly rate, then the number 1 is keyed in the |
| | Quantity of Service field and the monthly rate is |
| | keyed in the Basic Route Charges field. |
| Basic Route | See Quantity of Service. |
| Charges | |
| Tax | Enter the total tax in this field. Each |
| | state and/or country will have a different tax rate, |
| | it's up to the user to find this rate and calculates the |
| | total tax. |
| Total Charges | Calculated field that displays the sum of |
| | (Days of Service × Basic Route Charges) + Tax. |
| Unit Types | Drop-down list that contains the unit types. For |
| | a list of unit types, please see Unit Types herein |
| | below. All ATM service is OATM. Branch service |
| | will generally be ISB, MB, TRAD, or BUSCT. Any |
| | other type of location will be considered NONRT. |
| | If in doubt, ask what would be recommended. |
| Route Frequency | Descriptive field that displays the route frequency. |
| | For example, input 1 for one trip per week, 2 for |
| | two trips per week. |
| Route | Enter the name or number of the route to which the |
| | user has the service. The user may also enter the city |
| | name in this field if the user does not know the route |
| | information. |

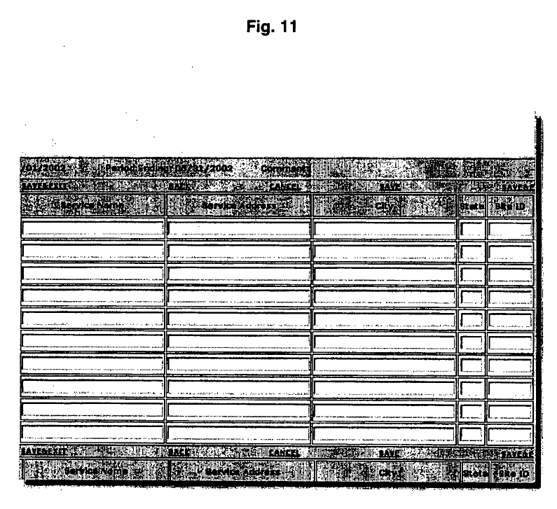

Refer to FIG. 11 for seeing the second portion of the Enter New Armored Invoice screen according to the invention. Table H herein below lists the corresponding fields of the second portion of the Enter New Armored Invoice screen

TABLE H

| | |
|---|---|
| Service Name | Descriptive name of the ATM site or Branch. |
| Service Address | Address of the ATM site or Branch. |
| City | City of the ATM site or Branch. |
| State | State of the ATM site or Branch. |
| Site ID | Repeat of the first field in the line. It is used for |
| | reference purposes If the user is in the second half |
| | of the input screen and cannot see the starting line |
| | information. |

Enter New Air Invoice

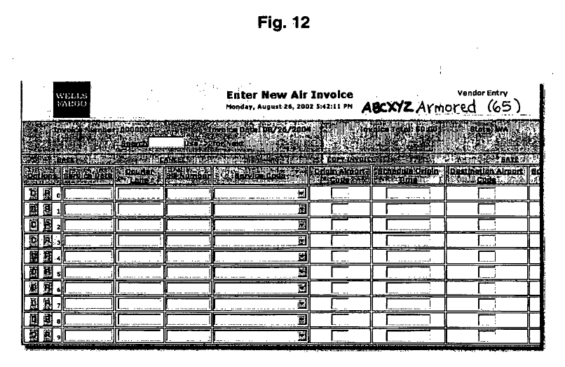

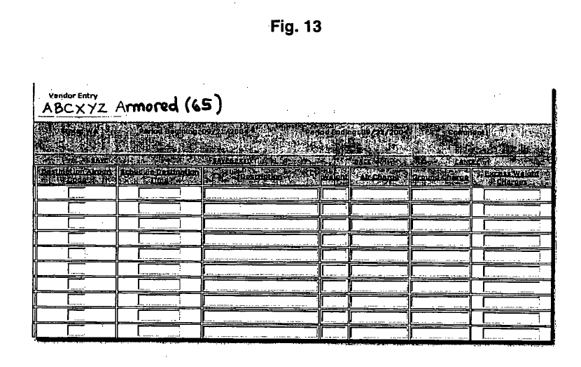

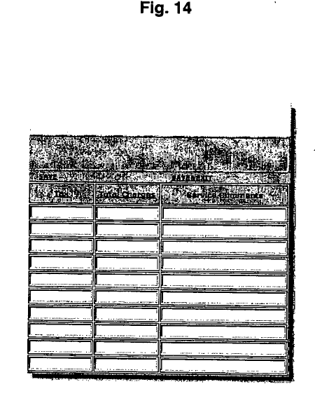

Refer to FIGS. 12-14, an Enter New Air Invoice screen according to the invention. This screen is displayed when Air is selected in the Invoice Type field and Add Lines from the Enter New Invoice screen is selected. The Enter New Air Invoice screen is available to the following groups: Vendor Entry, Vendor Manager, and Enterprise Enter.

For this discussion herein, this screen is broken into three sections, explaining each field.

The Enter New Air Invoice screen allows adding specific information to the invoice and contains the following fields as depicted in Tables I-K, herein below-:

TABLE I

| | |
|---|---|
| Invoice Number | Read-only field that displays the invoice number. |
| | This number is created in the Enter New Invoice |
| | screen. |
| Invoice Date | Read-only field that displays the date that this |
| | invoice was created. |
| Invoice Total | Read-only field that displays the invoice total. |
| State | Read-only field that displays the state that is |
| | associated with this invoice. |
| Search | Enter a word or value to search. Use > to go to |
| | the next instance of the word or value. |
| Back | Takes the user back to the Ent r New Inv ice |
| | screen. |
| Cancel | Cancels the new invoice process without saving |
| | any information. Takes the user back to the |
| | Main Menu. |
| Copy Invoice | Opens the Copy Inv ice screen. |
| Save | Saves the information and displays an additional |
| | 20 lines for more information. |
| Options | The Options column contains two buttons. |
| | D-Deletes a keyed or partially keyed line. Only |
| | delete if the user no longer needs or wants the |
| | information in the line. All information in that |
| | line will disappear and Deleted will show in the |
| | line detail. The user can key on a deleted line. |
| | If the user does not key on a deleted line, it will |
| | remain as a detail line until you SAVE. After |
| | saving, it will no longer be part of the invoice |
| | detail. |
| | R-Repeats a line. Select R on the line item the |
| | user wishes to repeat. The user can select a line to |
| | repeat from a keyed item on the invoice. All |
| | fields of the repeated line will show in the next |
| | available blank line. |
| Service Date | |
| Courrier Lane | |
| Bill Number | |
| Service Code | Required field that has a drop-down list that |
| | contains the service codes. For a complete list of |
| | service codes, please see Service Codes for Air |
| | herein below. |
| Origin Airport Code | Unknown |
| Schedule Airport | |
| Time | |
| Destination Airport | |
| Code | |

TABLE J

| | |
|---|---|
| Period Beginning | Read-only field that displays the begbinning period |
| | of the invoice. |
| Period Ending | Read-only field that displays the ending period of the |
| | invoice. |
| Comment | Read-only field that displays any comments or notes |
| | that you might have associated with the invoice. |
| Save & Exit | Saves the information and takes the user to the Main |
| | Menu. |
| Back | Takes the user back to the Enter New Invoice screen. |
| Cancel | Cancels the new invoice process without saving any |
| | information. Takes the user back to the Main Menu. |
| Schedule | |
| Destination Time | |
| Description | Contents of the package. |
| Weight | Vendor weighs package. |
| Air Charge | Cost of package for air. |
| Ground Charge | Cost of package for ground. |
| Excess Weight | Value agreed in contract. Value is excess beyond |
| Charges | the weight charge. |

TABLE K

| | |
|---|---|
| Save | Saves the information and displays an additional 20 |
| | lines for more information. |
| Save & Exit | Saves the information and takes the user to the Main |
| | Menu. |
| Tax | Enter the total tax in this field. Each state and/or |
| | county will have a different tax rate, it's up to the |
| | user to find this rate and calculate the total tax. |
| Total Charges | Calculated field that displays the sum of (Days of |
| | Service × Weight, Ground Charge, Air Charge, |
| | Excess Weight Charge) + Tax. Fuel Charges |
| | [Inventors: Please check that the above is correct. |
| | Thanks.] |
| Service Comments | |

Enter New Ground Invoice

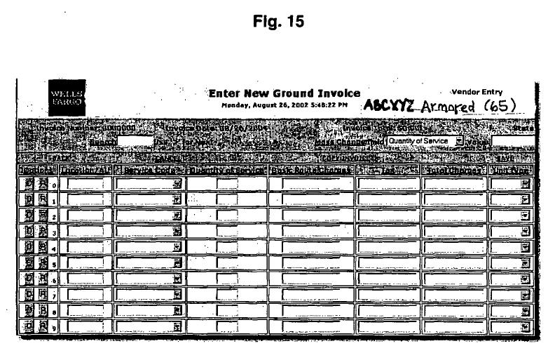

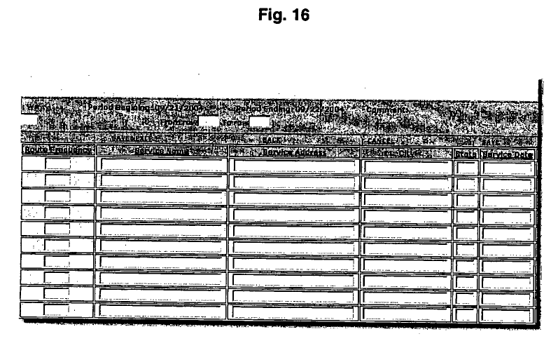

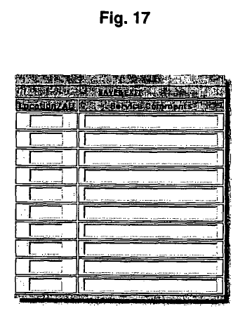

Refer to FIGS. 15-17, an Enter New Ground Invoice screen according to the invention. This screen is displayed when Ground is selected in the Invoice Type field and Add Lines from the Enter New Invoice screen is selected. The Enter New Ground Invoice screen is available to the following groups: Vendor Entry, Vendor Manager, and Enterprise Enter.

It should be appreciated that for this discussion, this screen is broken into three sections explaining each field in FIGS. 15-17 and in Tables L-N herein below.

The Enter New Ground Invoice screen allows adding specific information to the invoice and contains the following fields as depicted in Tables L-N:

TABLE L

| | |
|---|---|
| Invoice Number | Read-only field that displays the invoice number. The |
| | invoice number is created in the Enter New Invoice |
| | screen. |
| Invoice Date | Read-only field that displays the date in which the |
| | invoice was created. |
| Invoice Total | Read-only field that displays the total amount for the |
| | invoice. |
| Search | Enter a word or value to search. Use > to go to the |
| | next instance of the word or value. |
| Mass Change | Allows the user to change the value of items in the |
| | same column. |
| Value | |
| Back | |
| Cancel | |
| Copy Invoice | |
| Save | |
| Options | |
| Location/AU | |
| Service Code | |
| Quality of Service | |
| Basic Route | |
| Charges | |
| Tax | |
| Total Charges | |
| Unit Type | |

TABLE M

Route Frequency
Service Name
Service Address
City
State
Service Date

TABLE N

| | |
|---|---|
| Save & Exit | |
| Location/AU | |
| Service Comments | Enter any comments about the invoice. |

Example Service Codes for Armored

Following in Table O is a list of example service codes for armored transportation according to the invention.

TABLE O

| Armored | Abbreviation | Description |
|---|---|---|
| 043 | Std Cash | Standard ATM Cash Replenishment |
| 044 | Std Dep | Standard ATM Deposit Pulls |
| 045 | Std Comb | Standard Combined ATM Cash |
| | | Repl/Deposit pull service - Should not |
| | | normally be used |
| 046 | Emer Cash | ATM Emergency Cash |
| 047 | Urgent Cash | ATM Urgent Cash |
| 048 | ATM Supply | |
| 049 | STEM Chg | OTR/Remote/STEM/Shuttle charges |
| 051 | ATM Off Day | ATM Holiday or Weekend service |
| 052 | Misc ATM | Other ATM charges not included above |
| 053 | Insur Surchg | Insurance Surcharge not regularly used |
| 054 | Brnch Curr | Scheduled Branch Coin/Currency |
| 055 | Fed Run | Federal Reserve Run |
| 056 | Night Drop | Night Drop Service |
| 057 | Cust - Whlse | Billed services performed for Bank |
| | | customers |
| 058 | Ratio Adjust | Used only by one vendor |
| 060 | VLT Off Day | Branch Cash special |
| 061 | Misc VLT | Billed charges that do not relate to other |
| | | non-ATM service codes |
| 063 | EAPD/POD | Charges specifically related to EAPD |
| 064 | FLM Base | ATM FLM Flat rates |
| 065 | FLM Var | ATM FLM Variable charges |

Following in Table P is a list of example service codes for air transportation according to the invention.

Service Codes for Air

TABLE P

| Number | Abbreviation |
|---|---|
| 100 | Hub to Hub |
| 101 | Regional |
| 102 | M-D |
| 103 | Specials |
| 104 | Fuel Adj. |
| 105 | Insurance Surcharge |
| 106 | Fed Excise Tax |

Following in Table Q is a list of example service codes for ground transportation according to the invention.

Service Codes for Ground

TABLE Q

| Number | Abbreviation |
|---|---|
| 200 | Hub to Hub |
| 201 | Regional |
| 202 | M-D |
| 203 | Specials |
| 204 | Add-Del Adj |

Following in Table R is a list of example unit types according to the invention.

Unit Types

TABLE R

| Type Code | Type Name | Description |
|---|---|---|
| BUSCT | Business Center | Stand alone branch location with teller |
| | | and ATM services dedicated to business |
| | | customers only. |
| CLRGS | Clearings | |
| ISB | In-Store Branch | Grocery store branch location with teller |
| | | and ATM services. Has a private office |
| | | for customer meetings. (All in-store out- |
| | | let types are assigned by Physical |
| | | Distribution Strategy and Partner). |
| MB | Motor Bank | Staffed locations with teller services |
| | | (and sometimes ATM services) avail- |
| | | able by automobile only. |
| MTG | Mortgage | Mortgage Banking operation. |
| NONRT | Non-Retail | Stand alone locations dedicated to |
| | | Private Banking customers only or loca- |
| | | tions that do not provide Traditional |
| | | Branch services to consumer and |
| | | business customers. |
| OATM | Off-Site ATM | Stand alone location with ATM services |
| | | only. |
| RI | Return Items | |
| TRAD | Traditional | Stand alone branch location with teller |
| | Branch | and ATM services. |

Status Codes

Following in Table S is a list containing an example of all the Status Codes that may appear on an invoice. The list also contains definitions and what group may enter the codes.

TABLE S

| Status Code | Definition | Group Responsible |
|---|---|---|
| Entered | Initial invoice condition. The invoice | Vendor Entry |
| | is being input into the system. | Vendor Manager |
| | | Enterprise Entry |
| Submitted | The invoice detail has been | These groups can |
| | completed, all information about the | change the status to |
| | invoice has been entered into the | Submitted: |
| | system and the invoice is ready for | Vendor Submit |
| | Enterprise to review and approve. | Vendor Manager |
| Rejected | The invoice has been submitted by | These groups have |
| | the vendor but there are errors | the ability to reject |
| | determined in the Enterprise Verify | an invoice. |
| | function. The invoice must be sent | Enterprise Verify |
| | back to the vendor for correction. | Enterprise |
| | The status is changed to Rejected | Approval 5000 |
| | and provides the vendor the ability | Enterprise |
| | to correct and resubmit. | Approval 50000 |
| Reviewed | The invoice is free of mistakes and | These groups have |
| | ready to move forward into the | the ability to change |
| | approval process. | the status from |
| | | Submitted to |
| | | Reviewed: |
| | | Enterprise Verify |
| | | Enterprise |
| | | Approval 5000 |
| | | Enterprise |
| | | Approval 50000 |
| Approved1 | The invoice dollar amount is greater | These groups have |
| | than $5,000 and the first level | the ability to change |
| | approver agrees that the invoice is | the status to |
| | to be paid. The status is changed to | Approved1: |
| | Approved1 and moved to the next | Enterprise |
| | approval level. | Approval 5000 |
| | | Enterprise |
| | | Approval 50000 |
| Approved2 | The invoice dollar amount is greater | These groups have |
| | than $50,000 and the second level | the ability to change |
| | approver agrees that the invoice is | the status to |
| | to be paid. The status is changed to | Approved2: |
| | Approved2 and moved to the next | Enterprise |
| | approval level. | Approval 50000 |
| Ready for | The invoice is ready to be sent to | These groups have |
| A/P | Accounts Payable. All the necessary | the ability to change |
| | review is done. | the status to |
| | | Ready for A/P: |
| | | Enterprise |
| | | Approval 5000 for |
| | | invoices not |
| | | greater than |
| | | $5,000 |
| | | Enterprise |
| | | Approval 50000 |
| | | for invoices not |
| | | greater than |
| | | $50,000 |
| | | Enterprise |
| | | Approval 250000 |
| | | for invoices not |
| | | greater than |
| | | $250,000 |
| Sent to A/P | The invoice has been printed and | The group with the |
| | faxed to A/P. | authority to print |
| | | and change the |
| | | status is: |
| | | Enterprise A/P |
| Paid | The invoice has been paid by | The groups with the |
| | Accounts Payable. | authority to change |
| | | the status to Paid |
| | | are: |
| | | Enterprise Enter |
| | | Enterprise Verify |

Import Invoice File Screen

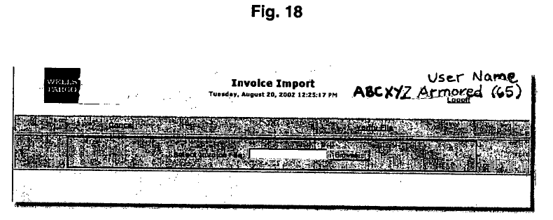

Refer to FIG. 18, an Invoice Import screen according to the invention. The Import Invoice File screen allows importing a Pipe Delimited File and is launched by clicking on Import File on the Enter New Invoice Screen. The groups that can import a file are: Vendor Entry, Vendor Manager, and Enterprise Enter.

The Import Invoice File screen has the following features as depicted in Table T herein below:

TABLE T

| | |
|---|---|
| Logoff | Logs the user off of the system. |
| Cancel | Cancels the file importing process. |
| Verify File | |
| Select Invoice File | Enter the location of the file the user wishes to |
| | import. |
| Browse | Opens a file requestor, allowing the user to search |
| | for and select the file the user wishes to import. |

A/P Invoice Screen

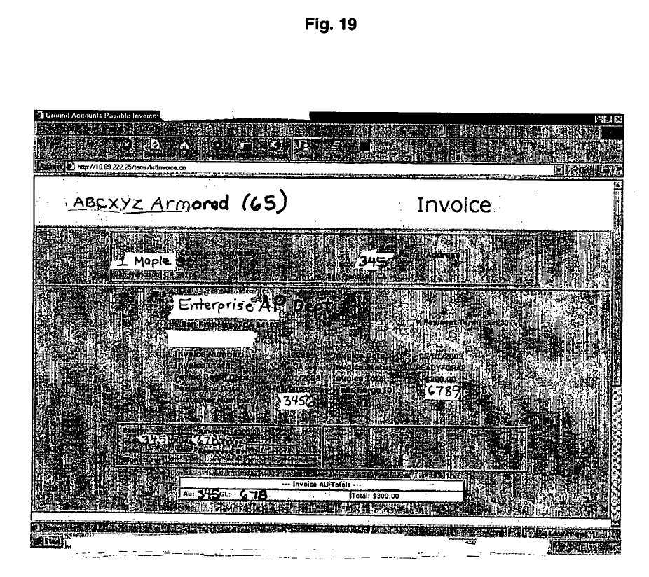

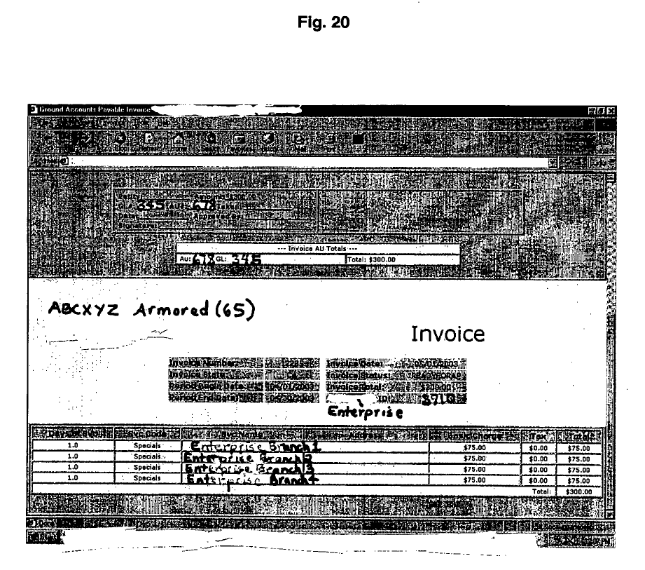

Refer to FIGS. 19 and 20 for example A/P invoice screen according to the invention.

Security Request Form

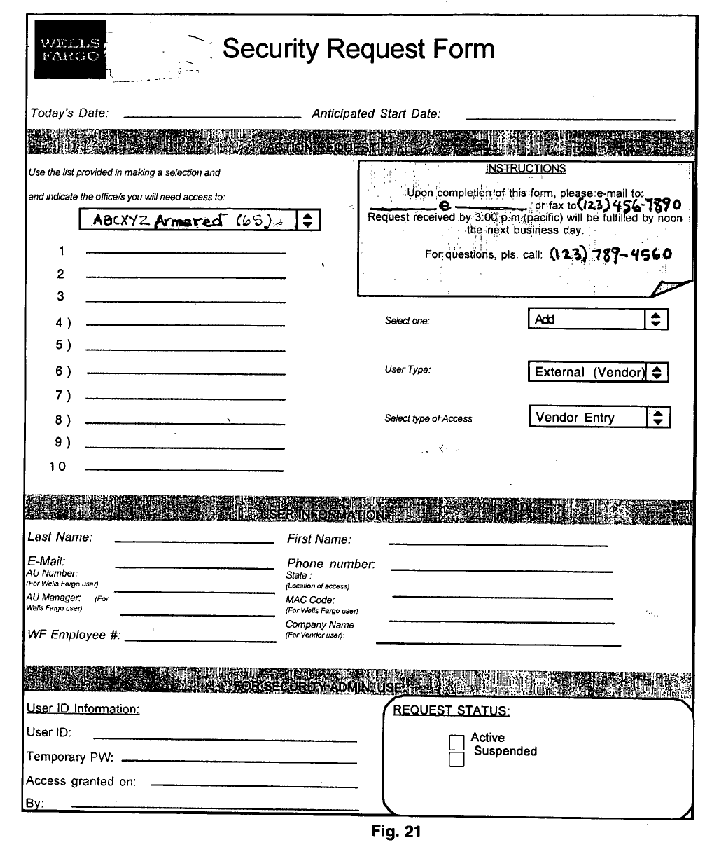

Refer to FIG. 21, a Security Request Form screen according to the invention. To use the Security Request form, a user can print that page and fill in the information. In addition, a user may also double-click on the form and a spreadsheet opens, allowing the user to make any edits desired.

### Example ATM Fault Servicing Related Data

Following are examples of data structures components for ATM fault servicing attachments and service files according to the invention.

Table U herein below contains example informational data of a particular ATM machine according to the invention. Such information is shared with transportation vendors, for example. It is also a component of service files.

TABLE U
ATM Attributes - ATM Table

ATM ID
Start (expense system field)
Date
End (expense system field)
Date
ATM Status
Site Name
Address
City
State
Zip
Manufacture
ATM Model
ATM (AIM Installation Type)
Type
ATM Serial # (from ATM World)
Org Live Date
Close Date
Network Monitoring Emulator -
device table

Table V herein below shows an example parts table according to the invention. Such table may be a part of the attachment file. An enterprise staff member maintains and edits this file.

TABLE V
Parts Table (Parts database, vendor's data periodically reloaded
with new files from the vendors - effective dated records)

Vendor
Start Date
End Date
Part number
Description 100
Cost

Table W herein below contains an example price factor subtable and an example ATM price subtable according to the invention. Table W is a main component of an attachment. An enterprise staff member maintains and edits this file.

TABLE W

| | |
|---|---|
| Price Factor Table | ATM price table |

(both files effective dated)

| | |
|---|---|
| Price Type | ATM ID |
| Region | Service code |
| Model | Cost |
| Service Code | |
| Cost Method * | |
| Cost per month | |
| Cost per hour | |
| Non-billable hours | |
| Cost per occurrence | |
| Excess calls tolerance | |

* 1 = per hr, 2 = per month
3 = per occurrence

Table X herein below is an example service file, specifically an example fault servicing record according to the invention. Such table shows example fields in a single record. An enterprise staff member maintains and edits this file.

TABLE X
Service File

| | |
|---|---|
| ATM ID | |
| Start date | |
| End date | |
| Region | (could be a state, or an area) |
| Price Type | (R = regional, M = by model #, |
| | RM = determined by Model and |
| | Region, A = by ATM ID) |

SLA - Repair Time xxx.xx hrs

| | |
|---|---|
| Allowance | |
| Parts Priced | (Y/N) |
| Unlimited Calls | (Y/N) |
| No. of Calls | # |
| Aggregated | (Y/N) |

Table Y herein below contains example service codes according to the invention. An enterprise staff member maintains and edits this file.

TABLE Y

| | | | Requires |
|---|---|---|---|
| | | | Trouble |
| | | | Ticket # |
| Service Codes | Description | How billed* | (Incident #) |
| First Line | | | |
| 501 | First line base | Type 2 | N |
| 502 | First line variable | Type 1 | Y |
| 503 | First line project | Type 1 | N |
| 504 | First line special/misc | Type 1 (Alert) | N |
| 505 | Conversion - hourly | Type 1 | N |
| | ($ per hour, xxx.xx) | | |
| 506 | Excess First Line Calls | Type 2 | N |
| Second Line | | | |
| 510 | Second line base | Type 2 | N |
| 511 | Second line variable | Type 1 | Y |
| 512 | Second line project | Type 1 | N |
| 513 | Second line special/misc | Type 1 (Alert) | N |
| 514 | Outside Service - Second | Type 2 | Y |
| | line | | |
| 515 | Conversion - hourly | Type 1 | N |
| | ($ per hour, xxx.xx) | | |
| 516 | Parts Charge Only | Type 1 | Y |

*How Billed - type of invoice:
Type 1 = variable
Type 2 = Monthly Base
**Suggested method of billing for excess calls:
Permit ATM ID field on Type 2 invoice to be blank for service code 506
Permit “Days of service” field to carry no. of excess calls if ATM ID = blank
Permit blank ATM Serial #, Unit Type, Machine Type, site Name, address, etc.

Table Z herein below is an example invoice data structure for invoices reflecting a dispatching assignment. An enterprise staff member maintains and edits this file.

TABLE Z
Invoice Screen Type 1 - Variable
(ATM Repair Invoice)

Date of Service
ATM ID
Enterprise Incident #
Vendor Incident #
Service Code
Quantity of Service
Part Replaced
Parts Charges
Labor Charges
Trip Charges
Local Tax
County Tax
State Tax
Total Tax
Total Charges
ATM Serial #
Unit Type (Offsite, etc.)
Machine Type (model)
Site Name
Address
City
State
Zip
Requested By
Time Received
Travel Time - Hrs.
Arrival Time
Time Completed
Total Time
Non-billable hours
Vendor Site ID
Comment

Table AA herein below is an example invoice data structure for invoices reflecting base maintenance and no dispatching. An enterprise staff member maintains and edits this file.

TABLE AA
Invoice Screen Type 2 - Base Charges
(ATM Fault Services, Mo.Charges)

Date of Service
ATM ID
Service Code
No. of Days of Service
Base Charge
Local Tax
County Tax
State Tax
Total Charges
Number of calls
ATM Serial #
Unit Type
Machine Type
Site Name
Address
City
State
Zip

Table AB herein below is an example invoice data structure given to vendors showing the format suggested for invoices reflecting a dispatching assignment, i.e. billing data. An enterprise staff member maintains and edits the format of this file.

TABLE AB
Invoice Record Format

Date of Service
ATM ID
Service Code
No. of Days of Service
Base Charge
Local Tax
County Tax
State Tax
Total Charges
Number of calls
ATM Serial #
Unit Type
Machine Type
Site Name
Address
City
State
Zip
Enterprise Incident #
Vendor Incident #
Part Replaced
Parts Charges
Labor Charges
Trip Charges
Requested By
Time Received
Travel Time - Hrs.
Arrival Time
Time Completed
Total Time
Non-billable hours
Vendor Site ID
Comment

Table AC herein below is an example data structure for a trouble ticket or incidents for when dispatchers were sent out to a particular ATM. The field, Ticket_ld(P) is used for matching up with vendor invoices, i.e. used for matching in the validation process according to the invention.

TABLE AC

| | |
|---|---|
| Device_Id (P) | ATM Number |
| Manufacture | Manufacture of the ATM |
| Model_Number | Model Number of ATM |
| Street Address | ATM Street Address |
| City | ATM City |
| State | ATM State |
| Zip | ATM Zip |
| Ticket_Id (P) | Unique ID for Recording the Device Transition from |
| | Available to Wounded or Unavailable |
| Incident_Id (P) | Unique ID for Recording Each Dispatchable |
| | Incident |
| Service_Level (P) | Level of Service Line |
| Ticket_Category | Problem Category of Ticket Affected by Fault |
| Fault | External Fault Code |
| Service_Provider | Actual Service Provider |
| ETA_Date | Date of Estimated Time of Arrival for Service |
| | Provider |
| ETA_Time | Time of Estimated Time of Arrival for Service |
| | Provider |
| F_Date | Date the Fault Code Affects the Device |
| F_Time | Time the Fault Code Affects the Device |
| A_Date | Date Positive Acknowledgement was Received |
| A_Time | Time Positive Acknowledgement was Received |
| O_Date | Date of Onsite Signal |
| O_Time | Time of Onsite Signal |
| R_Date | Date of Repair Complete Signal |
| R_Time | Time of Repair Complete Signal |
| Fault_Text | Fault Information |
| CLR_Date | Date Fault Reversal Signal was Received |
| CLR_Time | Time Fault Reversal Signal was Received |
| Component | Type of ATM Component Affected |

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. An online system for managing and validating enterprise expenses, said system comprising:
user interface means for collecting invoice data representing an invoice, and for displaying said collected data;
an invoice validation module for validating said collected invoice data against service data, and
a system of record for storing data, said stored data comprising said validated collected invoice data and said service data.

2. The online system of claim 1, further comprising any of:
a copy invoice module for creating a new invoice by making a copy of an old invoice and modifying particular data on said copied invoice;
a management report module for creating and displaying management reports using data stored in said system of record;
an accounts payable report module for performing any of:
creating an accounts payable report; and
submitting said accounts payable report directly to an accounts payable enterprise system for payment;
a cost savings module for determining savings by using said collected invoice data and by using said validated collected invoice data; and
an alerting management module for creating alerts of variances in said collected invoice data with some of or all of said service data.

3. The online system of claim 1, further comprising:
a security mechanism by which assigned users are limited to specific vendors, offices, and invoices.

4. The online system of claim 1, further comprising:
means for importing a vendor-created invoice data file.

5. The online system of claim 4, wherein said means for importing said vendor-created invoice file comprises the same editing capability as provided by said user interface means.

6. The online system of claim 4, wherein said vendor-created invoice file is a pipe delimited file.

7. The online system of claim 1, wherein said invoice validation module comprises calculation algorithms for validating invoice line items.

8. The online system of claim 1, further comprising any of:
means for offloading invoices to a spreadsheet file; and
means for printing invoice reports.

9. The online system of claim 1, further comprising:
means for loading service data from a spreadsheet file.

10. The online system of claim 1, further comprising any of:
means for rejecting said invoice using said user interface means;
means for correcting data of said rejected invoice;
means for changing an invoice status to verified based on said corrected data of said rejected invoice; and
means for moving said verified invoice into an approval mode.

11. The online system of claim 10, further comprising:
means for creating an actual invoice from said verified invoice and for sending said actual invoice to an accounts payable system.

12. The online system of claim 1, wherein said service data further comprises:
five levels, said five levels comprising:
a contract, wherein said contract comprises details about a contractual relationship between said enterprise and a party providing services, said contract further comprising:
at least one schedule data set, wherein said at least one schedule data set comprises details about an implementation of some portion of said contract, said at least one schedule data set further comprising;
at least one attachment data set, wherein said at least one attachment data set comprises pricing information for specific services at specific locations, said at least one attachment data set further comprising;
at least one service file, wherein said at least one service file comprises authorized locations and authorized services, said at least one service file further comprising;
at least one service file record, whereby said at least one service file can comprises only one type of data.

13. The online system of claim 12, further comprising any of:
means for effective dating, wherein a start date and an end date are used for matching said invoice, wherein said invoice is coupled to said start data and end data, with said at least one service file record, wherein said service file record is coupled to said start date and said end date;
a date synchronization mechanism for said service data wherein if an end date is set at one of said five levels, then said end date is applied all of said levels as appropriate.
means for enforcing effective data automatically by expiring old records and creating new records when modifying existing service files or attachments; and
ad hoc functionality comprising:
means for presenting particular system of record data in table view;
means for querying said data in said table view; and
means for constructing what-if scenarios using said means for querying.

14. A computer process for managing and validating an invoice from a vendor to an enterprise accounts payable system, said computer process comprising the steps of:
entering or modifying vendor invoice data and assigning said vendor invoice an original status of entered;
reviewing said entered vendor invoice data and changing said status to submitted;
reviewing said vendor invoice for accuracy and changing said status to either of rejected or reviewed;
if said status is rejected, then repeat from said step of entering or modifying vendor invoice data;
approving said invoice;
setting said status indicating ready for accounts payable; and
creating an accounts payable invoice.

15. The process of claim 14, further comprising any of the steps of:
printing said accounts payable invoice;
faxing said accounts payable invoice to said enterprise accounts payable system;
electronically sending said accounts payable invoice to said enterprise accounts payable system; and
changing said status indicating sent to accounts payable.

16. An online method for managing and validating enterprise expenses, said method comprising:
providing user interface means for collecting invoice data representing an invoice, and for displaying said collected data;
providing an invoice validation module for validating said collected invoice data against service data, and
providing a system of record for storing data, said stored data comprising said validated collected invoice data and said service data.

17. The online method of claim 16, further comprising any of the steps of:
providing a copy invoice module for creating a new invoice by making a copy of an old invoice and modifying particular data on said copied invoice;
providing a management report module for creating and displaying management reports using data stored in said system of record;
providing an accounts payable report module for performing any of the steps of:
creating an accounts payable report; and
submitting said accounts payable report directly to an accounts payable enterprise system for payment;
providing a cost savings module for determining savings by using said collected invoice data and by using said validated collected invoice data; and
providing an alerting management module for creating alerts of variances in said collected invoice data with some of or all of said service data.

18. The online method of claim 16, further comprising the steps of:
providing a security mechanism by which assigned users are limited to specific vendors, offices, and invoices.

19. The online method of claim 16, further comprising the step of:
importing a vendor-created invoice data file.

20. The online method of claim 19, wherein said step of importing said vendor-created invoice file comprises the same editing capability as provided by said user interface means.

21. The online method of claim 19, wherein said vendor-created invoice file is a pipe delimited file.

22. The online method of claim 16, wherein said invoice validation module comprises calculation algorithms for validating invoice line items.

23. The online method of claim 16, further comprising any of the steps of:
offloading invoices to a spreadsheet file; and
printing invoice reports.

24. The online method of claim 16, further comprising the step of:
loading service data from a spreadsheet file.

25. The online method of claim 16, further comprising any of the steps of:
rejecting said invoice using said user interface means;
correcting data of said rejected invoice;
changing an invoice status to verified based on said corrected data of said rejected invoice; and
moving said verified invoice into an approval mode.

26. The online method of claim 25, further comprising the step of:
creating an actual invoice from said verified invoice and for sending said actual invoice to an accounts payable system.

27. The online method of claim 16, wherein said service data further comprises:
five levels, said five levels comprising:
a contract, wherein said contract comprises details about a contractual relationship between said enterprise and a party providing services, said contract further comprising:
at least one schedule data set, wherein said at least one schedule data set comprises details about an implementation of some portion of said contract, said at least one schedule data set further comprising;
at least one attachment data set, wherein said at least one attachment data set comprises pricing information for specific services at specific locations, said at least one attachment data set further comprising;
at least one service file, wherein said at least one service file comprises authorized locations and authorized services, said at least one service file further comprising;
at least one service file record, whereby said at least one service file can comprises only one type of data.

28. The online method of claim 27, further comprising any of the steps of:
effective dating, wherein a start date and an end date are used for matching said invoice, wherein said invoice is coupled to said start data and end data, with said at least one service file record, wherein said service file record is coupled to said start date and said end date;
providing a date synchronization mechanism for said service data wherein if an end date is set at one of said five levels, then said end date is applied all of said levels as appropriate.
enforcing effective data automatically by expiring old records and creating new records when modifying existing service files or attachments; and
providing ad hoc functionality comprising:
means for presenting particular system of record data in table view;
means for querying said data in said table view; and
means for constructing what-if scenarios using said means for querying.
